(19) United States
(12) Patent Application Publication
(10) Pub. No.: US 2002/0005185 A1
(43) Pub. Date: Jan. 17, 2002

(54) Method and a supplemental valve assembly for controlling combustion air-supply in an internal combustion engine

(76) Inventor: Oskar Schatz, Gauting (DE)

Correspondence Address: HARNESS, DICKEY & PIERCE, PLC, P.O. BOX 828, BLOOMFIELD HILLS, MI, 48303, US

(21) Appl. No.: 09/904,801

(22) Filed: Jul. 13, 2001

(30) Foreign Application Priority Data
Jul. 14, 2000 (DE) 100-34-376.7
Apr. 18, 2001 (DE) 101-28-282.6

(51) Int. Cl. F02D 1/00; F02D 9/08

(52) U.S. Cl. 123/403; 123/336

(57) ABSTRACT

A method of controlling supply of combustion air in an internal combustion engine comprising at least one combustion chamber, a piston slidable in said combustion chamber and adapted to perform suction strokes, an inlet passage for feeding combustion air to said combustion chamber, an inlet valve for controlling flow of combustion air into said combustion chamber and adapted to be opened during opening periods, and a supplemental valve assembly disposed in said inlet passage and movable between opening and closing positions, in which method combustion air supply is selectively controlled by said supplemental valve assembly during said opening periods of said inlet valve such that combustion air supply to the combustion chamber during said suction strokes of the piston is interrupted prior to the end of the respective suction stroke or enabled only towards the end of the respective suction stroke or is enabled in two phases such that combustion air flows into the combustion chamber in a first phase during a first half of said opening periods of said inlet valve and in a second please during a last quarter of said opening periods of said inlet valve, wherein said supplemental valve assembly is controlled such that movements of a valve member thereof will be assisted by combustion air flow prevailing at that time in said inlet passage. Furthermore, there is provided a supplemental valve assembly for performing the above method.

### FIELD OF THE INVENTION

The present invention relates to a method of controlling supply of combustion air in an internal combustion engine and a supplemental valve assembly for performing such method.

### BACKGROUND OF THE INVENTION

German Patent DE 37 37 824 C2 discloses a method of controlling supply of combustion air in an internal combustion engine comprising at least one combustion chamber, a piston slidable in said combustion chamber and adapted to perform suction strokes an inlet passage for feeding combustion air to said combustion chamber, an inlet valve for controlling flow of combustion air into said combustion chamber and adapted to be opened during opening periods, and a supplemental valve assembly disposed in said inlet passage and movable between opening and closing positions, in which method combustion air supply is selectively controlled by said supplemental valve assembly during said opening periods of said inlet valve such that combustion air supply to the combustion chamber during said suction strokes of the piston is interrupted prior to the end of the respective suction stroke or enabled only towards the end of the respective suction stroke or is enabled in two phases such that combustion air flows into the combustion chamber in a first phase during a first half of said opening periods of said inlet valve and in a second phase during a last quarter of said opening periods of said inlet valve. This German patent discloses also a supplemental valve assembly for performing such method.

German patent DE 37 37 828 C2 discloses a supplemental valve assembly including a valve member which is designed as a pivotal flap. A pivotal valve flap which is mounted for pivotal movements about an eccentric axis is shown in German printed patent specification DE 196 00 501 A1.

In so-called sequential air supply methods, supply of combustion air into the combustion chamber of an internal combustion chamber is briefly interrupted by a supplemental valve when an associated piston is close to its bottom dead center. Since duration of free movement of the valve member of the supplemental valve must be very short, acceleration, braking forces and energy consumption of the supplemental valve are substantial, and therefore cost, weight and volume of the electrical drive of the supplemental valve are also substantial. It is in particular the space requirement of the drive that may cause substantial difficulties and problems in using such a method. Furthermore, substantial energy consumption will result in undesired heating of the components, and a complex control system may be required. In supercharging and heat loading methods using controlled check valves less expenditure is required; however, the range of different uses is greatly reduced as compared to the so-called sequential air supply.

### SUMMARY OF THE INVENTION

It is an object of the present invention to provide a method and a supplemental valve assembly for controlling supply of combustion air in an internal combustion engine which allow for sequential air supply.

It is a further object of the invention to provide for reduced weight and volume of the drive of such a supplemental valve assembly and to substantially reduce energy consumption of the drive.

It is a further object of the invention to provide such a method and supplemental valve assembly that allow to reduce the duration of free movement of the valve member of the supplemental valve assembly in order to improve efficiency of such method and to enable use of such method also at high engine speeds.

The present invention controls the supplemental valve assembly such that movements of the valve member thereof will be assisted by combustion air flow prevailing at that time in the inlet passage.

The inventor has recognized that pressure differences prevailing in the inlet passage in the area of the supplemental valve and changing during each cycle of operation can be used for acceleration of the opening and closing movements of the valve member of the supplemental valve assembly. The additional energy resulting from such pressure differences is used to increase the velocity of the valve member and to reduce the energy to be provided by the drive of the supplemental valve assembly. As a result thereof the volume, weight and cost of the supplemental valve drive will be reduced, and the velocity of the valve member of the supplemental valve assembly can be increased. Such pressure differences may become effective in different directions depending on the mode of operation and/or the respective phase of the cycle of operation. If the valve member of the supplemental valve assembly is formed as a pivotal flap which can be moved to its open position only in one direction as known in the prior art, the gas flow resulting from such pressure differences can not always be used to assist the movements of the valve member.

Therefore, a first version of a supplemental valve assembly comprises a pivotal flap mounted so as to be rotatable about an eccentric axis to a closing positions for closing the inlet passage, with the closing position being a central position of the pivotal flap which is movable from the closing position in a first direction of rotation to a first opening position and in an opposite direction of rotation to a second opening position for opening the inlet passage. This supplemental valve assembly can be opened and closed by movements in two opposite directions, with the respective movements of the valve member being assisted by the gas flow prevailing at this time in the inlet passage. Such assisting action can be used in a great number of applications.

The use of a pivotal flap movable from a central closing position in opposite directions of rotation to a pair of opening positions may cause flow losses due to sealing problems.

A second version of a supplemental valve assembly comprises a first pivotal flap mounted in a first branch conduit of the inlet passage for pivotal movements between opening and closing positions, and a second pivotal flap mounted in a second branch conduit of the inlet passage for pivotal movements between opening and closing positions. The first and second pivotal flaps each are arranged such that they engage respective abutment surfaces for closing their respective branch conduits when they are in their closing positions, and are adapted to be temporarily retained in their closing positions by controllable retaining means. The first and second pivotal flaps are arranged to be rotated in opposite directions for being moved from their respective closing positions towards their respective opening positions. Preferably the two branch conduits are disposed in a common housing.

If there are provided at least two inlet passages and at least two inlet valves for feeding combustion air to a combustion chamber, it is preferred that each of the inlet passages has associated therewith one of said branch conduits. However, it would be possible to provide each of the inlet passages with a pair of branch conduits. In this connection the respective intended use of the combustion engine and the applied charging methods should be taken into consideration.

A supplemental valve assembly in a modified second version comprises a first pivotal flap and a second pivotal flap which are arranged to be rotated in opposite directions for being moved from their respective closing positions towards their respective opening positions, with said pivotal flaps being positioned in the inlet passage such that one pivotal flap is downstream of the other pivotal flap.

Preferably, the pivotal flaps can be retained both in their closing and opening positions by controllable retaining means.

Furthermore, the pivotal flaps are arranged to be rotated through not more than an acute angle in order to reduce the “switching times” of the supplemental valve assembly.

As a safety feature, the flow cross-sectional area of the inlet passage should be closable by selected actuation of at least one valve flap under any operational condition in order to allow to shut off the combustion engine at any time.

The supplemental valve assembly of the present invention can be used to increase or reduce the amount of combustion air or for changing the temperature of the combustion air. Increase of the amount of combustion air can be used in suction-type combustion engines or charger-type combustion engines having oscillatory intake passages for dynamic charging of the engine, wherein the inlet passage may be opened once or twice per cycle. Furthermore, it can be used in Otto-type charged engines and Diesel-type charged engines for after-charging thereof and control of fresh air supply and charger air supply. Furthermore, it can be used in all combustion engine to reduce the amount of combustion air in connection with stratified gas operation, expansion operation and switch-off of selected cylinders as well as in Otto-type suction and charging engines for expansion of gas flow by early closing the inlet thereof. Finally, it is suited for changing the temperature of the combustion air in Otto- and Diesel-type charging engines by cold air charging and expansion of cooled charging air, as well as in all engines for heat charging by late opening of the inlet valve.

Other advantages and objects of the present invention will become apparent to those skilled in the art from the subsequent detailed description, appended claims and drawings.

### BRIEF DESCRIPTION OF THE DRAWINGS

In the drawings which illustrate the best modc presently contemplated for carrying out the present invention:

FIG. 1a is schematic cross-sectional view of a first embodiment of a supplemental valve assembly which is positioned in an inlet passage of an internal combustion engine upstream of an inlet valve and which is in a first opening position;

FIG. 1b a cross-sectional view similar to FIG. 1a, with the supplemental valve assembly being in its closing position;

FIG. 1c a cross-sectional view similar to FIG. 1a, with the supplemental valve assembly being in its second opening position;

FIG. 2a a cross-sectional view similar to FIG. 1a of a modified embodiment of the supplemental valve assembly;

FIG. 2b a cross-sectional view similar to FIG. 2a of the modified supplemental valve assembly;

FIG. 2c a cross-sectional view similar to FIG. 1c of the modified supplemental valve assembly;

FIG. 3 a cross-sectional view of a second embodiment of a supplemental valve assembly;

FIG. 4 a cross-sectional view of a modified version of the second embodiment of the supplemental valve assembly shown in FIG. 3.

### DETAILED DESCRIPTION OF THE PREFERRED EMBODIMENTS

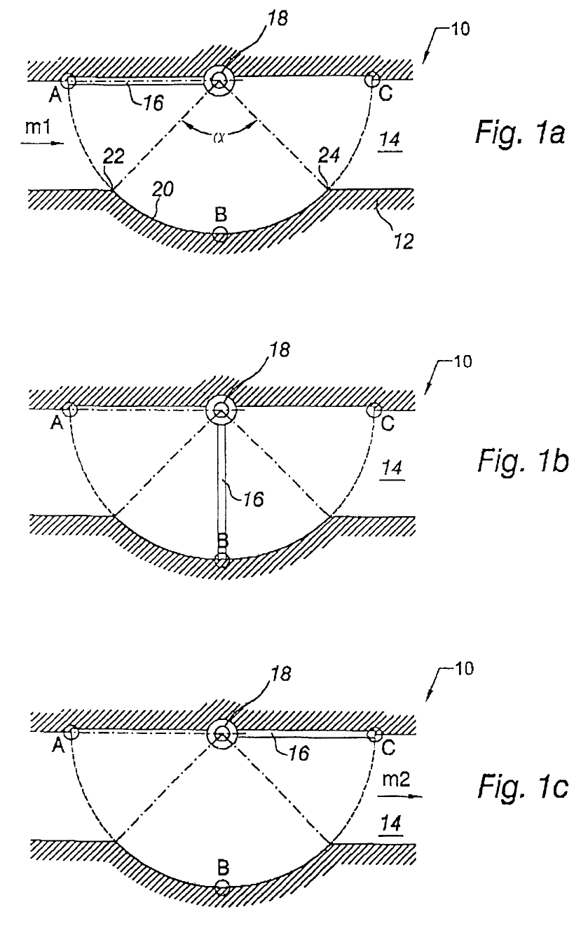

FIGS. 1a and c show a supplemental valve assembly 10 in positions wherein the gas to be fed to a combustion chamber (not shown) via an inlet valve (not shown) flows through the supplemental valve assembly from the right side to the left side (in the drawing).

The supplemental valve assembly 10 shown in FIGS. 1a to 1c includes a housing 12 which encloses a portion of an inlet passage 14 wherein a valve member comprising a pivotal flap 16 is fixed to a pivot shaft 18 so as to be rotatable about the axis of the pivot shaft 18. In the embodiment of FIGS. 1a to I c the pivotal flap 16 has one end fixed to the pivot shaft 18 which is disposed at one side of the inlet passage 14. A first opening position A, a closing position B and a second opening position C of the pivotal flap 16 are characterized by the positions which the edge of the pivotal flap 16 remote from the pivot shaft 18 will be positioned at. When the pivotal flap 16 is in any of opening positions A and C, it engages the side of the inlet passage 14 to which the pivot shaft 18 is mounted. The pivotal flap 16 rotates through an angle of 180° for moving from one opening position to the other opening position. The closing position B is arranged centrally between the two opening positions A and C.

The radial length of the pivotal flap 16 exceeds the spacing between the pivot shaft 18 and the opposite side of the inlet passage 14 such that the inlet passage is provided with an arcuate encircling surface 20 concentric with the pivot shaft 18 and extending between a pair of control edges 22 and 24 which are spaced from the closing position B by the same angle of rotation and which limit a closing range α. When the pivotal flap 16 is within said closing range a its free edge engages the encircling surface 20 such that the pivotal flap 16 closes the inlet passage 14, and the pivotal flap 16 opens the inlet passage 14 only after having passed any of the control edges 22 and 24 when moving towards any of the closing positions A and C. The angle of the closing range is dependent on the respective mode of operation and may be selected to be substantially less than shown. A greater angle can be selected to increase the breaking or acceleration energy available after closing and respectively, opening the valve.

The housing 12 may be provided with a much deeper pocket-like recess between the positions designated by A and C in FIGS. 1a to 1c so that e.g. movements of the pivot flap 16 are to be decelerated only when the pivotal flap has reached the opening position A or C without risk of collision.

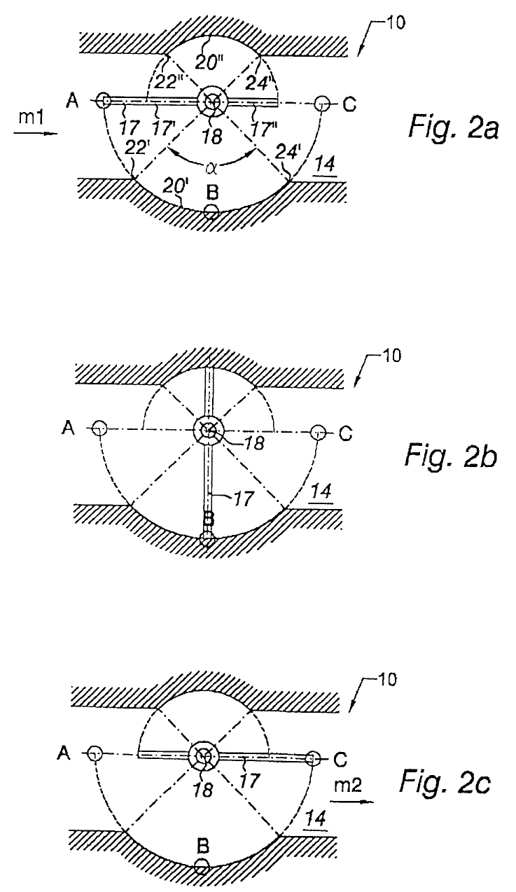

The embodiment shown in FIG. 2a to 2c differs from the first embodiment only in that the pivotal flap 17, by the pivot shaft 18, is divided into a portion 17′ of greater radial length, and a portion 17″ of smaller radial length, so that the pivot shaft 18 is radially spaced from the side walls of the inlet passage 14 which are opposite to each other in a direction transverse to the pivot shaft 18. Each of said side walls includes an encircling surface 20′ and, respectively, 20″ which cooperate with the respective edge of the pivotal flap portions 17′ and, respectively, 17′ in order to close the inlet passage 14 when the pivotal flap 17 rotates through the closing range α. The encircling surface 20′ is limited by control edges 22′ and 24′, and the encircling surface 20″ is limited by control edges 22″ and 24″.

The pivot shaft 18 is driven by a drive (not shown), for example an electrical drive. The pivotal flap 17 is controllable so that it can be held stationary in the positions A, B and C, at least however in the positions A and B. If desired, at least a part of the breaking energy resulting from deceleration of pivotal flap 16 or 17 may be stored and may be used for accelerating the pivotal flap thereafter. This may be obtained for example by resilient means and/or by switching the drive from motor operation to generator operation.

The supplemental valve assembly can be used for a great number of applications of which the following three load charging methods are of particular importance:

early termination of inlet opening as a measure for restriction free charge control in Otto-type engines,

very late inlet opening as a measure for heat loading during cold start,

sequential air supply and, respectively, charge exchange comprising a pair of subsequent inlet flow phases for dynamically charging the engine at low engine speeds.

The last mode of operation is a combination of the two first mentioned modes of operation and will be explained in more detail below, this allows to describe all types of valve movements and gas flow assisting such valve movements.

Prior to the beginning of the suction stroke the inlet valve of the combustion chamber and the supplemental valve assembly 10 are closed, and the pivotal flap 16 or 17 is in the position B. The space between the inlet valve (not shown) and the supplemental valve assembly will be called “valve space” in the following. This valve space contains, prior to the beginning of the suction stroke, air compressed in the preceding work cycle as will be explained in more detail below.

Immediately before the inlet valve adjacent the combustion chamber begins to move (inlet opening), the locking of the supplemental valve assembly 10 in the closing position B (FIGS. 1b, 2b) is released. The drive moves the pivotal flap 16 or 17 from the closing position B towards the opening position A. The compressed air in the valve space assists or enforces such movement of the valve flap until it passes the control edge 22 so as to abruptly open the inlet passage 14 and to release the air mass m1. Now the piston (not shown) which moves meanwhile towards its bottom dead center draws air (gas) into the combustion chamber. When the piston has moved to a position corresponding about 120° crank angle after its top dead center the drive begins to move the supplemental valve assembly 10 from the opening position A towards the closing position (FIG. 1a, 2a). The air mass m1 flowing towards the combustion chamber at high velocity hits upon the pivotal flap 16 or 17 so as to accelerate its movement until it passes the control edge 22. The ram pressure upstream of the pivotal flap 16 or 17 will be still active at that time. The air (gas) enclosed in the combustion chamber will expand due to further movement of the piston, and the air (gas) pressure acting upon the pivotal flap 16 or 17 will be further increased. On the other hand when the pivotal flap 16 or 17 approaches the closing position B the pivotal flap will be slowed down by the drive and will be retained in the closing position B, with the braking energy being regained to a certain extent.

The subpressure within the combustion chamber will increase until the pivotal flap 16 or 17 will be released by the locking means and will be moved by the drive towards the opening position 10. with the drive being assisted by the subpressure in the combustion chamber. As soon as the pivotal flap passes the control edge 24, the inlet passage 14 will be opened abruptly. The air mass m2 flows into the inlet passage at high velocity and also assists in rotating the pivotal flap.

When the pivotal flap 16 or 17 approaches the opening position C, it will be slowed down by the drive, and the inflowing air (gas) initially is slowed down in the combustion chamber resulting in a pressure increase. Eventually the air will tend to flow in the opposite direction so as to enforce or accelerate respective rotational movement of the pivotal flap 16 or 17 which again is moved by the drive to the closing position B where it will be retained (locked). Shortly thereafter the inlet valve of the combustion chamber will be closed so that the compressed air will be enclosed and retained in the valve space; such compressed air will assist in rotating the pivotal flap from position B to position A at the beginning of the next work cycle.

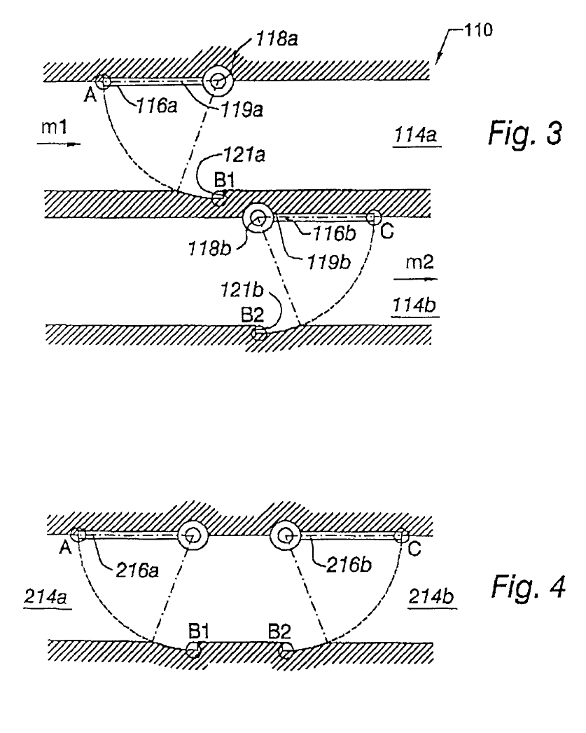

FIG. 3 shows a supplemental valve assembly 110 for a pair of branch conduits 114a and 114b which are combined in a common housing 12 so as to form a structural unit. Direction of gas flow to the inlet valve (not shown) of the combustion chamber (not shown) is from left to right in the drawing. A pivotal flap 116a is mounted in the branch conduit 114a so as to be rotatable about a pivot shaft 118a. The pivotal flap 116a when in its opening position is disposed within a pocket 119a of the housing 112 in order not to restrict fluid flow through the branch conduit 114a. The pivotal flap 116a can be rotated by an actuator (not shown) such as an electrical actuator outside of the housing 112 for about 45° clockwise from the open position to the closing position wherein it engages an abutment surface 121a. The above mentioned drive is also used to rotate the pivotal flap anticlockwise in the opening direction. Return spring means can be used to enforce closing movement of the pivotal flap. Furthermore, the pivotal flap 116a is retained in its opening position by retaining means such as a solenoid and, if desired, by a further retaining means such as a further solenoid; the retaining means can be made ineffective at any time by interrupting current supply to the respective solenoid. Instead of solenoid-type retaining means which may comprise magnetic locking means within a solenoid-type rotary drive, mechanical devices could be used.

The branch conduit 114b contains a similar arrangement, with similar or corresponding parts being designated by the same reference numerals as in the branch conduit 114a except that the letter a has been replaced by the letter b. The only difference between pivotal flaps 116a and 116b is that pivotal flap 116b moves clockwise to the opening position and anti-clockwise to the closing position.

Similar to the embodiments in FIGS. 1a to 2c the positions of the pivotal flap 116a are designated by the letters A and B1, and the positions of the pivotal flap 116b are designated by the letters B2 and C; this should make clear that the supplemental valve assembly of the second version as shown in FIG. 3 can be moved to the same positions as the supplemental valve assembly of the first version, and movements of the pivotal flaps 116a and 116b will be enforced or accelerated by the pressure and/or flow conditions prevailing at that time in the inlet passage in the same manner as in the embodiments of the first version.

When the pivotal flaps 116a and 116b are at rest, they are in the closed position. In the space between these pivotal flaps and the inlet valve (not shown) adjacent the combustion chamber there prevails a slightly super atmospheric pressure. This super atmospheric pressure assists in rotating the pivotal flap 116 from position B1 to position A after it has been released; this enables charging air to flow into the combustion chamber. This airflow will enforce or accelerate movement of the pivotal flap 116a from position A to position B1. The pivotal flap 116a will then be retained by the abutment surface 121a, and the pivotal flap 116b will be retained by retaining means associated with abutment surface 121b. A sub-atmospheric pressure will prevail in the space between the supplemental valve assembly 110 and the inlet valve adjacent the combustion chamber. Eventually, the retaining means will be made inoperative, the pivotal flap 116b will move from the closing position B2 to the opening position C, there will be pulse or vibrational charging of the piston, and before the gas charge can flow back, the retained pivotal flap 116b will be released so that it can return from opening position C to closing position B2.

In the embodiment of FIG. 4 pivotal flaps 216a and 216b similar to pivotal flaps 116a and 116b described with reference to FIG. 3 arc positioned in a common inlet passage within passage portions 214a and 214b following each other in the flow direction. Also in this arrangement it is to be assumed that the combustion chamber (not shown) is positioned towards the right from the supplemental valve assembly as shown. Gas flow towards the combustion chamber is suited to assist in closing pivotal flap 216a and in opening pivotal flap 216b, while gas flow from the combustion chamber or super-atmospheric pressure in the passage between the supplemental valve assembly and the combustion chamber is suited to assist in closing pivotal flap 216b and in opening pivotal flap 216a provided that the respective pivotal flap is released to perform such movements.

In the valve arrangements of FIGS. 1 and 2 the combustion engine can be brought to an emergency stop by moving the respective pivotal flap to closing position B. In the embodiment of FIG. 4 it could also be sufficient to move a pivotal flap, preferably pivotal flap 216a, to the closing position B1 to provide for an emergency stop. In the embodiment of FIG. 3. both pivotal flaps 116a and 116b must be moved to their closing positions B1 and B2 in order to stop air supply of the combustion engine.

When this description uses the term “air”, this term is not meant to be restrictive but rather, should encompass any gas a mixture of air, fuel and/or recirculated exhaust gas.

What is claimed is:

1. A method of controlling supply of combustion air in an internal combustion engine comprising at least one combustion chamber, a piston slidable in said combustion chamber and adapted to perform suction strokes, an inlet passage for feeding combustion air to said combustion chambers an inlet valve for controlling flow of combustion air into said combustion chamber and adapted to be opened during opening periods, and a supplemental valve assembly disposed in said inlet passage and movable between opening and closing positions, in which method combustion air supply is selectively controlled by said supplemental valve assembly during said opening periods of said inlet valve such that combustion air supply to the combustion chamber during said suction strokes of the piston is interrupted prior to the end of the respective suction stroke or enabled only towards the end of the respective suction stroke or is enabled in two phases such that combustion air flows into the combustion chamber in a first phase during a first half of said opening periods of said inlet valve and in a second phase during a last quarter of said opening periods of said inlet valve, wherein said supplemental valve assembly is controlled such that movements of a valve member thereof will be assisted by combustion air flow prevailing at that time in said inlet passage.

2. A supplemental valve assembly for controlling supply of combustion air in an internal combustion engine comprising at least one combustion chamber, a piston slidable in said combustion chamber and adapted to perform suction strokes, an inlet passage for feeding combustion air to said combustion chamber, an inlet valve for controlling flow of combustion air into said combustion chamber and adapted to be opened during opening periods, and a supplemental valve assembly disposed in said inlet passage and movable between opening and closing positions, wherein combustion air supply is selectively controlled by said supplemental valve assembly during said opening periods of said inlet valve such that combustion air supply to the combustion chamber during said suction strokes of the piston is interrupted prior to the end of the respective suction stroke or enabled only towards the end of the respective suction stroke or is enabled in two phases such that combustion air flows into the combustion chamber in a first phase during a first half of said opening periods of said inlet valve and in a second phase during a last quarter of said opening periods of said inlet valve, with said supplemental valve assembly being controlled such that movements of a valve member thereof will be assisted by combustion air flow prevailing at that time in said inlet passage, said supplemental valve assembly comprising a pivotal flap mounted so as to be rotatable about an eccentric axis to a closing position for closing said inlet passage, said closing position being a central position of said pivotal flap which is movable from said closing position in a first direction of rotation to a first opening position and in an opposite direction of rotation to a second opening position for opening said inlet passage.

3. The supplemental valve assembly of claim 2, further comprising a valve housing including an encircling surface for providing closing ranges on opposite sides of said closing position and being of a shape enabling rotational movements of said pivotal flap in closely adjacent relationship, said encircling surface being limited by a pair of control edges such that said inlet passage is closed when said pivotal flap is moving through said closing ranges and will be opened as soon as said pivotal flap passes any of said control edges when moving towards any of said opening positions.

4. The supplemental valve assembly of claim 3, further comprising a controllable drive adapted to move said pivotal flap from any of its opening and closing positions to any adjacent of said opening and closing positions and to retain said pivotal flap in said adjacent position for any selected time.

5. The supplemental valve assembly of claim 4, wherein said drive includes means adapted to store at least a part of the energy obtained by braking said pivotal flap and to use the stored energy for any next following acceleration of said pivotal flap.

6. A supplemental valve assembly for controlling supply of combustion air in an internal combustion engine comprising at least one combustion chamber, a piston slidable in said combustion chamber and adapted to perform suction strokes, an inlet passage for feeding combustion air to said combustion chamber, an inlet valve for controlling flow of combustion air into said combustion chamber and adapted to be opened during opening periods, and a supplemental valve assembly disposed in said inlet passage and movable between opening and closing positions, wherein combustion air supply is selectively controlled by said supplemental valve assembly during said opening periods of said inlet valve such that combustion air supply to the combustion chamber during said suction strokes of the piston is interrupted prior to the end of the respective suction stroke or enabled only towards the end of the respective suction stroke or is enabled in two phases such that combustion air flows into the combustion chamber in a first phase during a first half of said opening periods of said inlet valve and in a second phase during a last quarter of said opening periods of said inlet valve, said supplemental valve assembly comprising a first pivotal flap mounted in a first branch conduit of said inlet passage for pivotal movements between opening and closing positions, and a second pivotal flap mounted in a second branch conduit of said inlet passage for pivotal movements between opening and closing positions, said first and second pivotal flaps each engaging a respective abutment surface for closing its respective branch conduit when being in its closing position and adapted to be temporarily retained in its closing position by controllable retaining means, said first and second pivotal flaps being arranged to be rotated in opposite directions for being moved from their respective closing positions towards their respective opening positions.

7. The supplemental valve assembly of claim 6, wherein said first and second branch conduits of said inlet passage are disposed in a common housing.

8. The supplemental valve assembly of claim 6, wherein said combustion chamber has associated therewith at least two inlet valves and two inlet passages, one of said inlet passages having associated therewith one of said branch conduits and the other of said inlet passages having associated therewith the other of said branch conduits.

9. A supplemental valve assembly for controlling supply of combustion air in an internal combustion engine comprising at least one combustion chamber, a piston slidable in said combustion chamber and adapted to perform suction strokes, an inlet passage for feeding combustion air to said combustion chamber, an inlet valve for controlling flow of combustion air into said combustion chamber and adapted to be opened during opening periods, and a supplemental valve assembly disposed in said inlet passage and movable between opening and closing positions, wherein combustion air supply is selectively controlled by said supplemental valve assembly during said opening periods of said inlet valve such that combustion air supply to the combustion chamber during said suction strokes of the piston is interrupted prior to the end of the respective suction stroke or enabled only towards the end of the respective suction stroke or is enabled in two phases such that combustion air flows into the combustion chamber in a first phase during a first half of said opening periods of said inlet valve and in a second phase during a last quarter of said opening periods of said inlet valve, said supplemental valve assembly comprising a first pivotal flap mounted for pivotal movements in said inlet passage between opening and closing positions, and a second pivotal flap mounted in said inlet passage for pivotal movements between opening and closing positions, said first and second pivotal flaps each engaging a respective abutment surface for closing its respective branch conduit when being in its closing position and adapted to be temporarily retained in its closing position by controllable retaining means, said first and second pivotal flaps being arranged to be rotated in opposite directions for being moved from their respective closing positions towards their respective opening positions and being positioned in said inlet passage such that said second pivotal flap is downstream of said first pivotal flap.

10. The supplemental valve assembly of claim 6, wherein each of said first and second pivotal flaps is adapted to be retained in its opening position by controllable retaining means.

11. The supplemental valve assembly of claim 6, wherein each of said first and second pivotal flaps is adapted to be rotated through not more than an acute angle.

12. The supplemental valve assembly of claim 9, wherein each of said first and second pivotal flaps is adapted to be retained in its opening position by controllable retaining means.

13. The supplemental valve assembly of claim 9, wherein each of said first and second pivotal flaps is adapted to be retained in its opening position by controllable retaining means.

14. The supplemental valve assembly of claim 2 wherein the flow cross-sectional area of said inlet passage is adapted to be closed by selected actuation of at least one valve flap under any operational condition.

15. The supplemental valve assembly of claim 2, further comprising electro-mechanically operated locking means acting upon said valve flap via a pivot shaft thereof.

16. The supplemental valve assembly of claim 15, wherein said electro-mechanically operated locking means is adapted to slow down said valve flap when moving to a desired end position prior to locking said pivotal flap in said end position.
